(19) United States
(12) Patent Application Publication
(10) Pub. No.: US 2016/0140115 A1
(43) Pub. Date: May 19, 2016

(54) Strategies for indexing, ranking and clustering multimedia documents

(71) Applicant: Reginald L. Walker, Long Beach, CA (US)

(72) Inventor: Reginald L. Walker, Los Angeles, CA (US)

(73) Assignee: Tapicu Inc., Long Beach, CA (US)

(21) Appl. No.: 14/756,348

(22) Filed: Sep. 1, 2015

Related U.S. Application Data
(63) Continuation-in-part of application No. 13/135,943, filed on Jul. 19, 2011, now Pat. No. 8,825,562.
Application No. 13/135,943 is a continuation-in-part of application No. 62/123,221, filed on Nov. 10, 2014.

(51) Int. Cl. G06F 17/30

(52) U.S. Cl. CPC G06F 17/3002; G06F 17/30705; G06F 17/30616

(57) ABSTRACT

A method for a system that indexes, ranks, and clusters multimedia documents using organizing means, scoring means, and stochastic means that optimizes parameter sets comprising of object parameters. The method creates a plurality of individual parameter sets, the parameter sets comprising information sharing system object parameters for describing a model, structures, shape, design, process, search query sets, and dynamic search spaces to be optimized using selective variations, constructive variations, clustering variations, and stochastic variations. The optimizations of the search space are guided by document query terms of the search query set object parameter. The search space is defined in terms of the terminal set, function set, and fitness measures (NN computations). The quality and speed of an EC application is controlled by the algorithm control parameters (the rates associated with node selection and document migration) and terminal criterion (continuous search for optimal distribution of multimedia documents). Satisfying the terminal criteria for the optimization of the dynamic search space object parameter which provides a synchronization point in which additional multimedia documents can be added to the global multimedia document object parameter.

### CROSS-REFERENCE TO RELATED APPLICATIONS

This application claims benefit of provisional patent application No. 62/070,676, filed on Sep. 2, 2014, by the present inventor. This application claims benefit of continuation-in-part of U.S. provisional patent application No. 62/123,221, filed on Nov. 10, 2014, by the present inventor. This application claims benefit of continuation-in-part of U.S. patent application Ser. No. 14/545,524, filed on May 15, 2015, by the present inventor. This application claims benefit of continuation-in-part of U.S. patent application Ser. No. 13/135,943, filed on Jul. 19, 2011, now U.S. Pat. No. 8,825,562. Each of the above-referenced applications are incorporated herein by reference in their entirety.

### FEDERALLY SPONSORED RESEARCH

Not Applicable

### SEQUENCE LISTING OR PROGRAM

Not Applicable

### BACKGROUND OF THE INVENTION

The invention relates generally to the optimizing of object parameters for describing a model, structure, shape, design, or process, for an information sharing indexer system. In particular, it relates to the stochastic optimization of evolutionary computation (EC) search strategy parameters for multimedia indexers for information sharing indexer systems such as search engines, data warehouses, and service oriented architectures (SOAs). The field of evolutionary computation encompasses stochastic optimization techniques, such as randomized search strategies, in the form of evolutionary strategies (ES), evolutionary programming (EP), genetic algorithms (GA), classifier systems, evolvable hardware (EHW), and genetic programming (GP).

There has always been a need to iteratively improve the clustering and ranking of multimedia documents. The stochastic optimization techniques of evolutionary computation (EC) contain mechanisms which enable the representation of certain unique aspects of individual behavior to improve document clustering. Principles of the stochastic optimization techniques of EC can be found for example in Reginald Louis Walker (2003) “Tocorime Apicu: Design of an Experimental Search Engine Using an Information Sharing Model”, University of California Dissertation, UMI Dissertation Publishing, Ann Arbor, Mich. 48106-1346, which is incorporated by reference herein in its entirety.

The chief differences among the various types of EC stemming from: 1) the representation of solutions (known as individuals in EC), 2) the design of the variation operators (mutation and/or recombination—also known as crossover), and 3) selection mechanisms. A common strength of these optimization approaches lies in the use of hybrid algorithms derived by combining two or more of the evolutionary search methodologies. The underlying optimization methodologies of EC are used to implement unique stochastic aspects of search strategies that are combined with information retrieval methodologies. This mapping is extended by supplementing the search strategies with finding hidden knowledge in a collection of multimedia documents—related and/or unrelated—using search query sets. Canonical multimedia documents are generated to reduce the workload and storage requirements of the system, resulting in a set of condensed multimedia documents forming the data store. The system continuously repartitions the stored document space among a set of nodes whose goal is to form subclusters of nodes for redistributing the workload. The subclusters are formed by using the information retrieval (IR) algorithm metrics coupled with two or more evolutionary search strategies as the basis of nearest neighbor clusters (NNC) among multimedia indexers. Fitness proportionate and tournament selection in this application forms the basis of nearest neighbor clustering, providing the mechanism for selecting nodes that will share information. Mutations and recombinations are implemented as random change (or multiple changes) of the description of the finite state machine (FSM) according to five different modifications: change of an output symbol, change of a state transition, addition of a state, deletion of a state, or change of the initial state.

### BACKGROUND OF THE INVENTION—OBJECTIVES

Accordingly, the objectives and advantages of the invention are as follows:

It is an objective of the present invention to use hybrid algorithms derived by combining one or more of the information retrieval methodologies with one or more of the evolutionary computation search methodologies.

It is another objective of the present invention is to provide a stochastic selection process that iteratively improves a population of solutions—evolving sets of competing solutions over the space being searched. The components of an optimization application are:
1. Terminal set. Input variables or constants.
2. Function set. Domain-specific functions that construct potential solutions.
3. Fitness measure(s). Function(s) that assign numeric values to the individuals associated with a population (set of solutions that comprise the solution space).
4. Algorithm control parameters. Settings dependent on population size and workload redistribution (recombination and mutation) rates.
5. Termination criterion. Predicate that uses fitness measures to determine the appropriateness of a population based on tolerances or limits on the number of allowable generations/iterations.

It is another objective of the present invention to represent solutions as memes to reduce in the computational effort to achieve the periodic optimal document clusters. The fitness of a species (adaptive and iterative grouping of the solutions from selective indexers) can be improved by the non-genetic transmission of cultural information that uses a meme as the transmission mechanism rather than the genetically based gene. The difference between the two includes the fact that genetic transmissions (stochastic selection process) evolve over a period of generations, whereas cultural transmissions result from an educational process.

It is another objective of the present invention to use a function set that consists of a multimedia parser that works as a two-pass parser. The initial pass occurs as a component of the system that applies document layout analysis for its automated retrieval component. The second pass applies a full set of text-processing modules consisting of syntactic analysis, lexical analysis, layout analysis, and feature recognition. Layout analysis transforms a raw document into an application-specific document by saving the canonical format structural information as necessary. The syntactic analysis component verifies that the canonical structure adheres to a suitable format. The lexical analysis module is combined with the feature recognition module. These modules remove stop words, identify and record word boundaries, and index words for retrieval. Additionally, this component is responsible for converting hyphenated and sequences of capitalized words into proximity constraints, and case conversions into compressed inverted files.

It is another objective of the present invention to continuously apply algorithm control parameters to improve the subclustering of documents in distributive applications leading to disjoint nodes for chosen sets of search queries.

It is another objective of the present invention to continuously adjust the operational parameters required to filter, organize, and index any large-scale data set—information stored on a single computer, a local area network (LAN), and a wide area network (WAN) that encompasses the whole Internet—that may consists of constantly fluctuating information content over relatively short periods of time.

### SUMMARY OF THE INVENTION

The invention is a system and method for indexing, ranking, and clustering multimedia documents using hybrid search strategies and the stochastic optimization techniques of evolutionary computation (EC). These stochastic optimization techniques form the basis of a regulatory mechanism for sharing information document clustering and ranking which leads to the migration of multimedia documents between multimedia indexers. The iterative application of these mechanisms improves the subclustering of multimedia documents in distributive applications leading to disjoint nodes for chosen sets of search queries according to one embodiment.

In one embodiment, a plurality of individual parameter sets are created wherein the parameter sets comprise information sharing system object parameters for describing a model, structures, shape, design, process, search query sets, and dynamic search spaces to be optimized using selective variations, constructive variations, clustering variations, and stochastic variations. The optimizations are guided by document query terms of the search query set object parameter.

It is to be understood that both foregoing general description and the following detailed description for the present invention are exemplary and explanatory and are extended to provide further explanation of the invention as claimed.

### DETAILED DESCRIPTION OF THE DRAWINGS—FIGURES

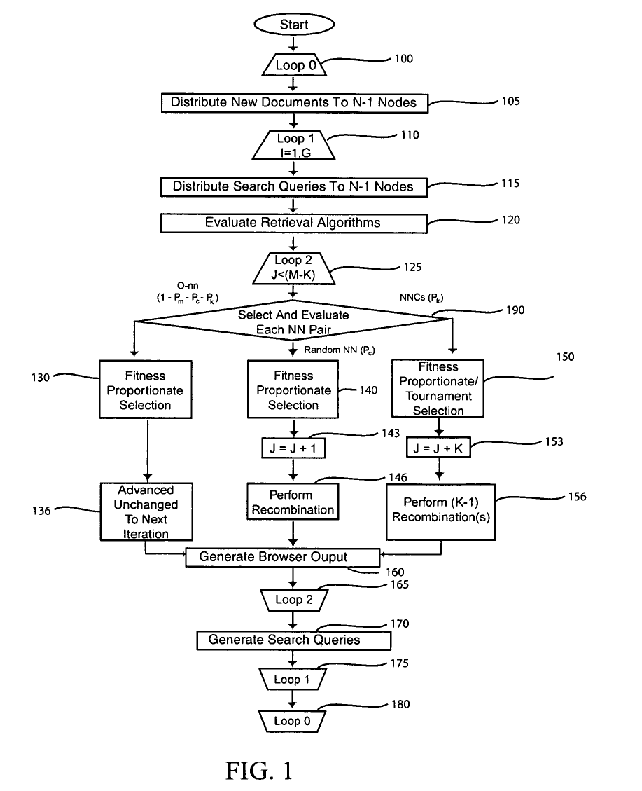

FIG. 1 is a schematic flow diagram of the optimization method of the present invention.

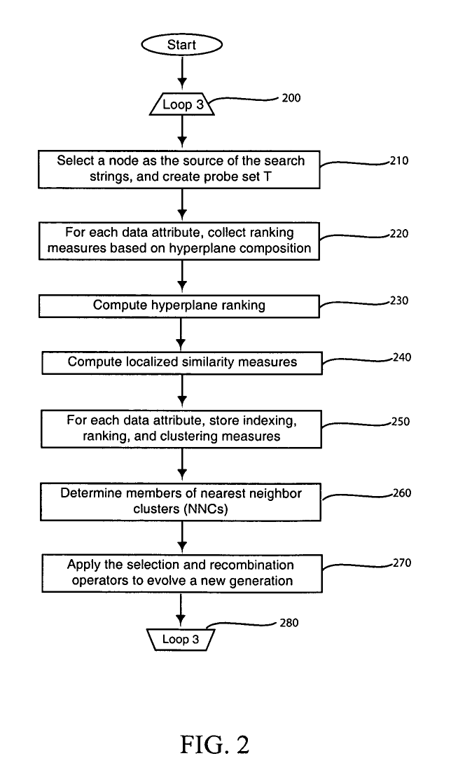

FIG. 2 is illustrates a flow diagram for optimizing object parameters of parameter sets using assessment means, scoring means, stochastic means, and organizing means to generate ranking scores, indexing scores, and clustering scores

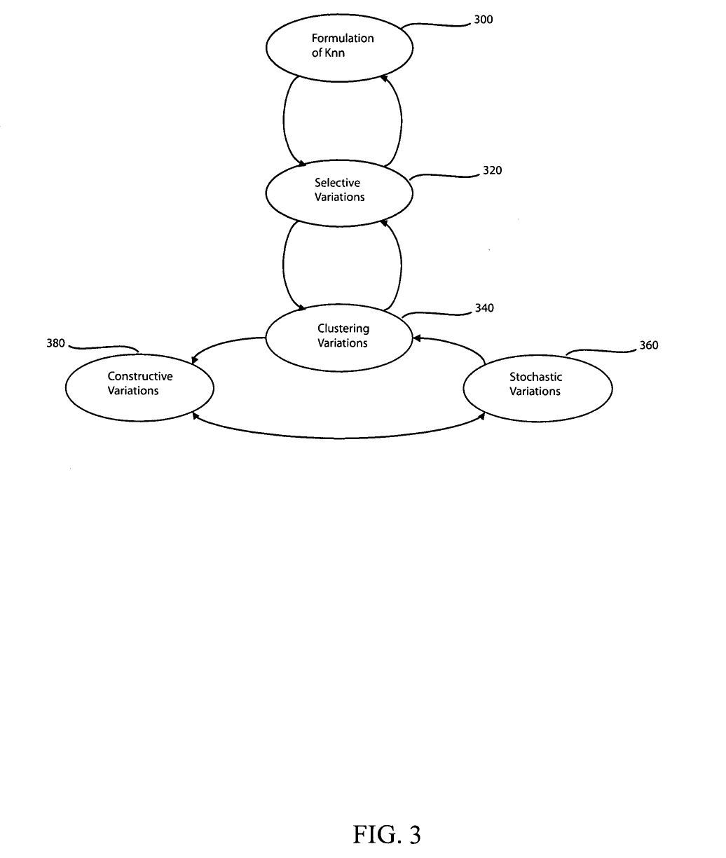

FIG. 3 is an illustration of the optimization strategies using selective variations, constructive variations, clustering variations, and stochastic variations.

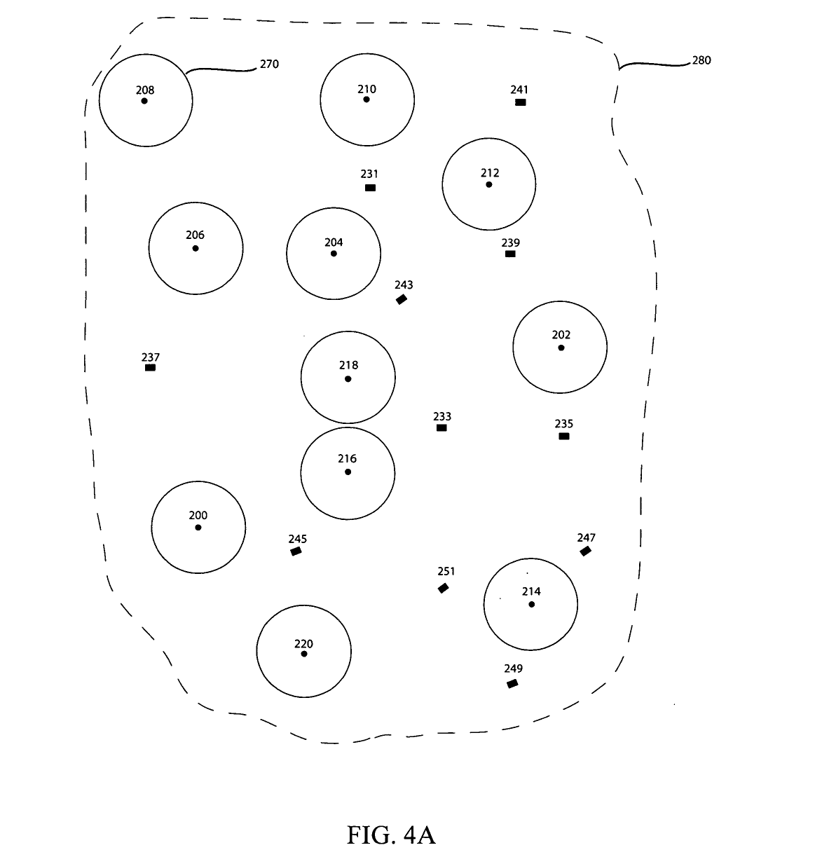

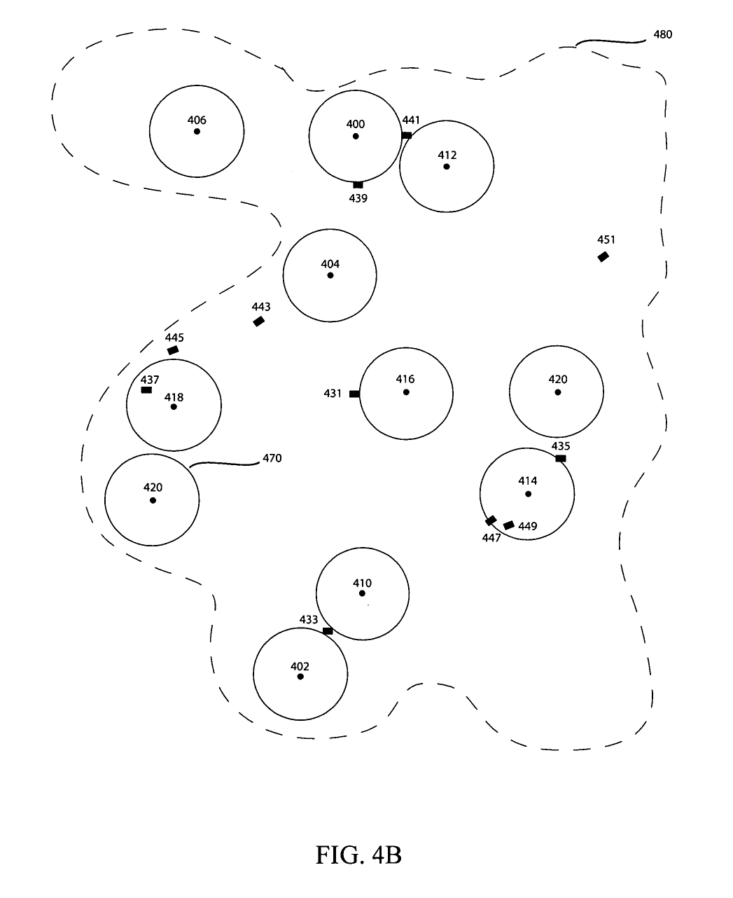

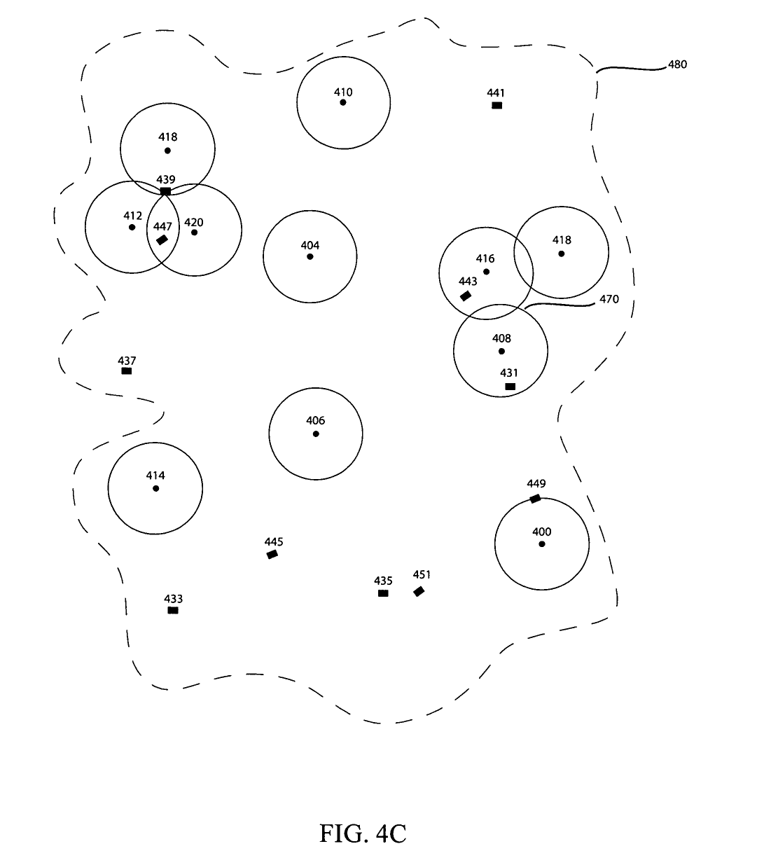

FIG. 4A is an illustration of random nearest neighbors in the dynamic search space at iteration tᵢ, in accordance with one or more embodiments.

FIG. 4B is an illustration of disjoint nearest neighbor clusters (NNCs) in the dynamic search space at iteration tᵢ₊ₘ, in accordance with one or more embodiments.

FIG. 4C is an illustration of overlapping nearest neighbor clusters (NNCs) in the dynamic search space at iteration tᵢ₊ₘ₊ₚ, in accordance with one or more embodiments.

### DETAILED DESCRIPTION—PREFERRED EMBODIMENTS

A preferred embodiment of the present invention is now described with reference to the figures where like reference numbers indicate identical or functionally similar elements.

Some portions of the detailed descriptions that follow are presented in terms of algorithms and symbolic representations of operations on data bits within a computer memory. These algorithmic descriptions and representations are the means used by those skilled in data processing art to most effectively convey the substance of their work to others skilled in the art. Algorithms are here, and generally, conceived to be self-consistence sequence of steps (instructions) leading to desired results. The steps are those requiring physical manipulations of physical quantities.

Certain aspects of the present invention include process steps and instructions described herein in the form of an algorithm. It should be noted that the process steps and instructions of the present invention could be embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in a computer. Furthermore, the computers referred to in the specifications may include a single processor or may be architectures employing multiple processors designed for increased computing capability.

The algorithms and displays presented herein are not inherently related to any particular computer of other apparatus. Various general-purpose systems may also be used with programs in accordance with the teaching herein, or it may prove convenient to construct more specialized apparatus to perform the required method steps. The required structure for a variety of these systems will appear from the description below. In addition, the present invention is not described with reference to any programming language. It will be appreciated that a variety of programming languages may be used to implement the teachings of the present invention as describe herein, and any references below to specific languages are provided for disclosure of enablement and best mode of the present invention.

In addition, the language used in the specification has been principally selected for readability and instructional purposes, and may not have been selected to delineate or circumscribed the invention subject matter. Accordingly, the disclosure of the present invention is intended to be illustrative, but not limiting, of the scope of the invention, which is set forth in the claims.

### 1. Notational Conventions

a. Applying the EC Search Strategies to Stochastic Information Fluctuations

FIG. 1 shows an embodiment of the invention which performs the tasks associated with regulating the formulation of NNCs and adapting to information fluctuations. The tasks performed are:
1. Periodic partitioning of the multimedia document dataset among indexer nodes 105
2. Generating workload assignments (resulting from fitness proportionate selection steps) for each node 105
3. Distributing dynamic workload assignments 105 and dynamic search query sets 115
4. Formulating NNCs using fitness proportionate selection 190
5. Selecting source of dynamic search query sets 170
6. Repeating step 1 through 5 100-180

The traditional EC approach for the recombination and mutation operators, as well as the normal (steady-state) approach, is restricted to one application per iteration for a single set of solutions. The load-balancing model of the multimedia document indexing system uses the EC recombination operator by restricting information sharing between members of disjoint node sets (species) which are chosen in a process that selects and evaluate each nearest neighbor (NN) pair 190.

NNCs 190 can occur as one of three types based on the number of neighborhood seeds: 1) random seeds, 2) multiple seeds, or 3) overlapping seeds. The occurrence of multiple and overlapping seeds enhances the quality of the total cluster's solution space via the modification of the workload assignments of several nodes during one iteration (superstep).

The iterative formulation of NNCs 125,190 was implemented using the notion of an expandable search space which facilitates adaptive subclusters on an iteration-by-iteration basis. The selection process 190 can be applied multiple times 153, where one node is the NN seed for one or more nodes—thus providing a stochastic hybrid of the recombination and mutation operators 130,140,150.
b. Formulation of Nearest Neighbor Clusters (NNCs)

K-nearest neighbors (K-nn) 190,130,136 is implanted as the mutation operator when K=0.

Random NN 190,140,143,146 are implemented as follows: 1) the first node is randomly chosen, and 2) the second node is chosen by incrementing the node ID of the first node 190, thereby mimicking the ring communication pattern based on the rank in order to determine adjacent nodes. Recombination is applied to the selected nodes 140,143,146 for each iteration 125-165. The proportionate fitness method 140 assigns a random number to each neighborhood seed and selects individuals by repeatedly choosing various random numbers until one matches a node's random number.

Multiple neighborhoods (NNCs) 190,150,153,156 exists when there are at least one or more NNCs in which neighborhoods do not overlap. When a single node is a nearest neighbor of two disjoint NNCs, this node may be selected 150 as a NN one or more times based on the existence of one or more completing nodes in the disjoint neighborhoods. The selection of a node when two or more are present in a single neighborhood occurs via proportionate fitness selection 150.

Overlapping neighborhoods 190,150,153,156 occur when two or more NNCs are formed from the seeds overlapping neighborhoods. The selection of one of the NNCs 150 from overlapping of neighborhoods occurs via two “popular” selection methodologies: 1) the proportionate fitness or roulette wheel selection, and 2) the tournament selection. The proportionate fitness method 150 assigns a random number to each node and selects individuals choosing various random numbers which may match an individual's random number.

The selection processes 190,150 for overlapping neighborhoods uses the radius of two or more nodes resulting in possibly K-nn per cluster by performing the following:
1. Randomly selects one of the overlapping nodes as the seed of one of the NNCs using the tournament selection method 150
2. Using roulette wheel selection 150
   a. Randomly selects a node for recombination
   b. Randomly selects a range for recombination
   c. Performs recombination 156 on the two nodes only if they are NN using proportionate fitness method 150
3. If necessary, repeats step 2 125-165
   The number of iterations 156 a selected node is used for recombination is random—this potentially providing the node with an emulator of the mutation operator 130 (occurring if the selected node was previously selected during an application of the recombination operator). However, the same node may be chosen for two or more iterations with the possibility of swapping previously exchanged recombinations. The system does not advance until k possible recombinations 156 have been completed. The occurrence of overlapping NNCs regulates the recombination rate and the selection rate. The recombination rate and the selection rate use the information retrieval algorithms to generate stochastic metrics for determining nearest neighbor (NN) resulting in the emergence of subclustering within each cluster/subcluster since each meme is maintained throughout this application.

Another component of the recombination rate and the selection rate stems from overlapping nearest neighbor clusters (NNCs) and is equivalent to sharing information between diverse set of computer processors and/or systems. This phenomenon adds random noise to the whole process by creating, at most K-nn in one component of a superstep based on overlapping NNCs—an event which is beneficial to the prevention of premature convergence and to the incorporation of various optimization techniques such as supersteps and dissassortive mating when selecting nodes from initial subclusters such subspecies A and B. Supersteps resulted from two or more applications of the recombination operator during one iteration (generation) via overlapping NNCs or multiple disjoint NNCs. Dissassortive selection is a results of selecting NN for the recombination operator from a disjoint list of disjoint subcluster members, as in the case of random NN using the even nodes as one cluster of individuals and the odd nodes as a subcluster.
c. Input Parameters

The methodology used in retrieval calculations 120—computing the stochastic measurements—was based on: 1) generating the canonical representation of the raw multimedia documents—an application-specific document of structural information, and 2) applying the stochastic optimization retrieval algorithms to determine NNCs 190—computing the raw fitness, standardized fitness, and adjusted fitness.
d. Synchronization Points

FIG. 1 provides periodic synchronization points 165,175,180 used for consistency restoration. Using a self-scheduling policy, the load-balancing model distributes the multimedia documents 105 that comprise the document dataset for each iteration. This random approach to the distribution of documents enables the system to adapt to each machine's characteristics at various stages of this iterative process 100-180. By requiring that each node start each iteration 100,110,125 on the basis of a consistent state, the synchronization points are used to restore a consistent global state. FIG. 1 allows for continuous updates and redistribution of multimedia documents 105,115,160,170 which incorporate the local and system-wide computational parameter adjustments.

The need for synchronization points 165,175,180 can be traced to scientific applications that are known to exhibit a diverse set of I/O access patterns. These are known as:
1. Compulsory
2. Checkpoint/restart
3. Regular snapshots of the computation's progress
4. Out-of-core read/writes
5. Continuous output of data for visualization and other post-processing
   The variability in the canonical document size accounts for the seemingly high random file accesses. Combining the file access patterns of all the indexers in the system reflects their compulsory nature. The synchronization points 165,175,180 provide the I/O checkpoints. The regular snapshots of the computation's progress are reflected in the intermediate solutions 160,170 that are created at the end of each iteration 165,175,180.
e. Local Optimizing of the Object Parameter Sets

FIG. 2 lists the steps for illustrates a flow diagram for optimizing object parameters of parameter sets using assessment means, scoring means, stochastic means, and organizing means to generating ranking scores, indexing, scores, and clustering scores to obtain an ever increasing and better understanding of an ever-changing environment in order to find various types of hidden knowledge based on the complexity of the implemented model.

The discovery of hidden knowledge for ranking, indexing, and clustering multimedia documents incorporates two broadly labeled groups known as summarization algorithms—which find concise information contained in the input data, and anomaly detection algorithms—which identify unusual features of the data, to optimize the object parameters of parameter set. A subgrouping within these approaches stems from classificatory algorithms which partition data into disjoint groups.

The major components associated with the optimization model:
1) Assessment means to generate object parameters to represent problems specific discrete attributes
2) Scoring means to provide a numerical assessment of the quality of discrete problem attributes which are represented as object parameters
3) Stochastic means to provide classification tasks, knowledge engineering tasks, and generating hyperplane partitions within the search space
4) Organizing means to provide historical aspects of the object parameter sets (preservation of indexing, ranking, and clustering scores for each search query set term)

The major steps for this approach are shown below
1) Select a node as the source of the search strings, and create probe set T 210
2) For each data attribute, collect ranking measures based on hyperplane composition 220
3) Compute the hyperplane ranking 230
4) Compute localized similarity measures 240
5) Optimizing object parameters of parameter sets using assessment means, scoring means, stochastic means, and organizing means 250
6) Determine the members of the distinct species (nearest neighbors) 260
7) Apply the selection and recombination operators to evolve a new generation 270
8) Repeat above steps (1-6) 200-280
f. Optimizing the Parameter Sets

The global optimization of parameter sets is guided scoring means and stochastic means leading to the intermediate state of the formulation of Knn 300 as shown in FIG. 3. The members of each Knn are a result of applying scoring means to each parameter set to determine its rank among the population of parameter sets. The application of stochastic means to the members of each Knn leads to selective variations 320, constructive variations 380, clustering variations 340, and stochastic variations 360. The indexing, ranking, and clustering of parameter sets following formulation of Knn 300 is needed before applying stochastic means to determine nearest neighbors within each Knn using chosen object parameters. Applying stochastic means to each Knn clusters of parameter sets for chosen object parameters for selective variations 320 results in clustering variations 340 in the composition of the selected parameter sets. The clustering variations 340 can occur two or more times before selective variations 320, constructive variations 380, and stochastic variations 360 occurs. Likewise, the combination of clustering variations 340 and constructive variations 380, or clustering variations 340 and stochastic variations 360 can occur zero or more times before selective variations 320 occurs following the formulation of Knn 300. Following the formulation of Knn 300, various combinations of selective variations 320, constructive variations 380, clustering variations 340, and stochastic variations 360 can occur zero or more times. Scoring means are re-applied after the all variations are completed.

While particular embodiments and applications of the present invention have been illustrated and described herein, it is understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.
g. Optimizing the Population of Memes within the Dynamic Search Space

FIGS. 4A, 4B, and 4C illustrate snapshots of plurality of individual memes that comprise of parameter set that contain information sharing system object parameters for describing a model, structures, shape, design, process, search query sets, and dynamic search spaces to be optimized using selective variations, constructive variations, clustering variations, and stochastic variations. The optimizations are guided by document query terms of the search query set object parameter within the dynamic search space 480. The dynamic search space 480 used in the discovery of NNC clusters, in the form of hyperplanes, may have arbitrary shapes such as nonconvex, spherical, drawn-out linear, elongated, etc. as shown in FIG. 4A, FIG. 4B, and FIG. 4C.

The parameter sets are separated into two groups to facilitate optimizations that result from selective variations, constructive variations, clustering variations, and stochastic variations by stochastic means. One group is labeled as the even numbered memes which are represented as circles at the center of a neighborhood boundary circle 470 used to establish the existence of a nearest neighbor 400,402,404,406,408,410,412, 414,416,418, 420 such as random NN shown in FIG. 4A, disjoint NNCs shown in FIG. 4B, or overlapping NNCs shown in FIG. 4C. The other group of memes is labeled as the odd numbered parameter sets 431,433,435,437,439,441,443,445,447,449,451.

Updating the parameter set in a meme by applying assessment means, scoring means, and stochastic means guide search queries based on indexing score values, ranking score values, and clustering score values for each index term in the search query set object parameter to improve the feasibility of the meme population 400,402,404,406, 408,410,412,414,416,418, 420, 431,433,435,437,439,441,443,445,447,449,451. Scoring means are used for indexing, ranking, and cluster each term in the index of multimedia document object parameter that is driven by the stochastic means. Stochastic means are used to generate selection variations, constructive variations, clustering variations, stochastic variations, and nearest neighbor clustering in parameter sets of memes 400,402,404,406,408,410,412,414,416,418, 420, 431,433,435,437,439,441,443,445,447, 449,451, and populations of memes.

Organizing means are used to cluster, index, and rank results from the index of multimedia documents structure object parameter which are guided by document query terms of the search query set object parameter within the dynamic search space 480. These means are applied repeatedly until achieving a periodic optimal multimedia document cluster parameter sets for all possible document query terms of the search query set object parameter. This process is driven by the size of the meme population 400,402,404,406,408,410,412,414,416,418, 420,431,433,435,437,439,441,443,445,447, 449,451.

While particular embodiments and applications of the present invention have been illustrated and described herein, it is understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

I claim:

1. A method for indexing, ranking, and clustering multimedia documents by optimizing memes consisting of parameter sets using selective variations, constructive variations, clustering variations, and stochastic variations comprising the steps of:
creating an initial population of a plurity of individual parameter sets based on the multimedia documents, the parameter sets comprising information sharing system object parameters for describing a model, structure, shape, design, process, search query set, and dynamic search space to optimized;
assessing the quality of each object parameter for a parameter set applying assessment means, scoring means, and stochastic means to guide search queries based on indexing score values, ranking score values, and clustering score values for each index term in the search query set object parameter;
optimizing the object parameters applying stochastic means to guide selective variations, constructive variations, clustering variations, and stochastic variations in nearest neighbor clusters of parameter sets;
formulating nearest neighbor clusters of parameter sets for the transmission of cultural information resulting from applying stochastic means until no nearest neighbor clusters of two or more parameter sets are found;
grouping indexing scores, ranking scores, and clustering scores for using organizing means document query terms of the search query set object parameter to form structure index term object parameters for each query term; and
repeating all steps until achieving a periodic optimal multimedia clusters parameter sets.

2. The method of claim 1 wherein a search query set object parameter formed of one or more new index terms from selected index of multimedia documents for document queries.

3. The method of claim 2 wherein removing from the search query set object parameter one or more index terms used in document queries.

4. The method of claim 2 wherein the indexing, ranking, and clustering of the terms in each multimedia documents is guided by applying scoring means to the document query terms of the search query set object parameter.

5. The method of claim 1 wherein grouping of multimedia documents by applying organizing means to the indexing scores, ranking scores, and clustering scores to create a structure index term object parameter for each query term.

6. The method of claim 5 wherein stochastic means are applied to organizing mean results to determine stochastic score for each query term.

7. The method of claim 6 wherein organizing means results are overwritten for a structure index term object parameter that exists from a previous nearest neighbor clustering that reflects an improvement in the stochastic score of the new structure index term object parameter.

8. The method of claim 4 wherein indexing, ranking, and clustering of parameter sets is guided by applying scoring means to the terms of the search query set object parameter.

9. The method of claim 4 wherein selective variations, constructive variations, clustering variations, and stochastic variations of parameter sets is guided by applying scoring means to the terms of the search query set object parameter.

10. The method of claim 9 wherein stochastically selected parameter sets are iteratively improved by stochastic means.

11. The method of claim 1 wherein the shape of the dynamic search space variations reflect the stochastic means that guide selective variations, constructive variations, clustering variations, and stochastic variations in parameter set for describing information sharing system object parameters for describing a model, structure, shape, design, process, search query set, and dynamic search space to be optimized.

12. The method of claim 11 wherein the shape of the dynamic search space variations reflect the stochastic means that guide optimizing selective variations, constructive variations, clustering variations, and stochastic variations in the population of parameter sets.

13. A system that indexes, ranks, and clusters multimedia documents by optimizing all object parameters of parameter sets using selective variations, constructive variations, clustering variations, and stochastic variations comprising the steps of:
creating an initial population of parameter sets based on the multimedia documents, the parameter sets comprising information sharing system object parameters for describing a model, structure, shape, design, process, search query set, and dynamic search space to optimized;
assessing the quality of each parameter set in nearest neighbor clusters of parameter sets by scoring means and stochastic means to guide selective variations, constructive variations, clustering variations, and stochastic variations;
formulating clusters of object parameters for the transmission of cultural information resulting from applying stochastic means until no nearest neighbor clusters of two or more parameter sets are found;
grouping multimedia document based on computed scores for each document query term of the search query set object parameter; and
repeating all steps until achieving a periodic optimal multimedia document clusters parameter sets for all possible document query terms of the search query set object parameter.

14. A system of claim 13 wherein the indexing, ranking, and clustering of multimedia documents within the population of parameter sets is guided by scoring means, stochastic means, and organizing means of document query terms of the search query set object parameter.

15. A system of claim 13 wherein the indexing, ranking, and clustering of multimedia documents within the population of parameter sets is guided by selective variations, constructive variations, clustering variations, and stochastic variations in clusters of object parameter sets means of document query terms of the search query set object parameter.

16. A system of claim 13 wherein the grouping of multimedia documents within the population of parameter sets relies on the combination of indexing, ranking, and clustering of multimedia documents coupled with selective variations, constructive variations, clustering variations, and stochastic variations guided by document query terms of the search query set object parameter.
